(19) United States
(12) Patent Application Publication
(10) Pub. No.: US 2003/0136267 A1
(43) Pub. Date: Jul. 24, 2003

(54) Air deodorizer

(76) Inventor: Joseph P. Ku, Castro Valley, CA (US)

Correspondence Address: BURNS, DOANE, SWECKER & MATHIS, L.L.P., P.O. Box 1404, Alexandria, VA, 22313-1404, US

(21) Appl. No.: 10/331,273

(22) Filed: Dec. 27, 2002

Related U.S. Application Data
(60) Provisional application No. 60/342,763, filed on Dec. 28, 2001.

(51) Int. Cl. B01D 53/02

(52) U.S. Cl. 96/135; 55/518

(57) ABSTRACT

An air deodorizer, including a housing having at least one opening permitting air flow therethrough; and activated carbon stored within the housing.

### RELATED APPLICATION

This application claims priority under 35 U.S.C. §119 to U.S. Provisional Application No. 60/342,763, entitled Air Deodorizer, filed on Dec. 28, 2001, the entire contents of which is hereby incorporated herein by reference.

### SUMMARY OF THE INVENTION

The present invention comprises an air deodorizer which is safe for use around foods and is thus ideally suited for use in a refrigerator.

In preferred aspects, the present invention provides: a housing through which air flows with activated carbon stored within the housing. The present invention may simply be placed into a refrigerator, where it then absorbs unpleasant odors.

In optional preferred aspects, material such as pellets which remove ethylene gas may also be placed within the housing to release ethylene, which advantageously delays spoiling of produce.

### BRIEF DESCRIPTION OF THE DRAWINGS

FIG. 1 is an exploded perspective view of the air deodorizer.

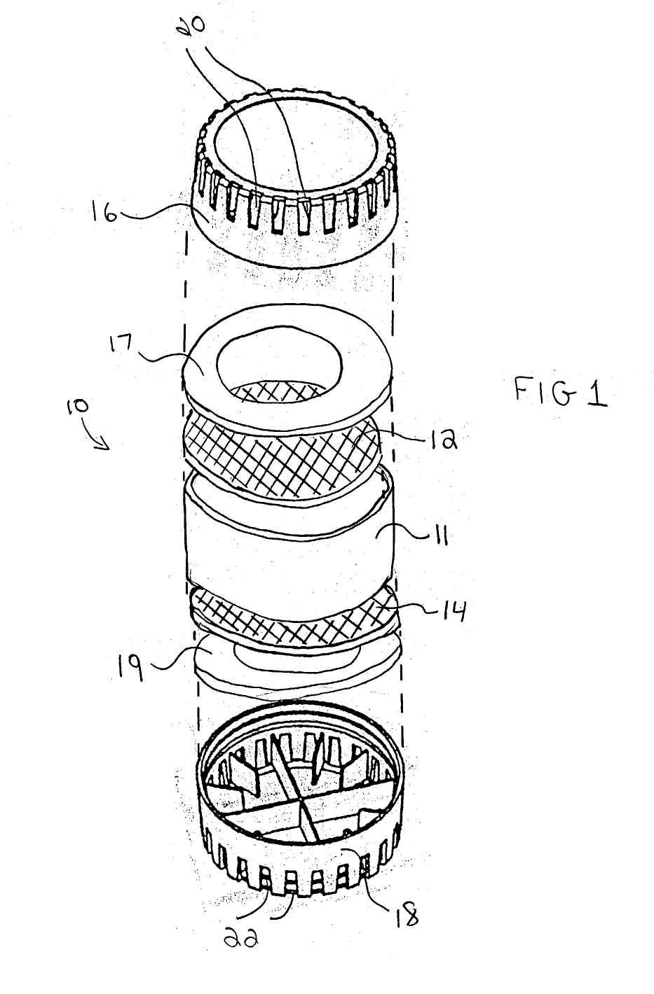

FIG. 2 is a side elevation view of the assembled air deodorizer.

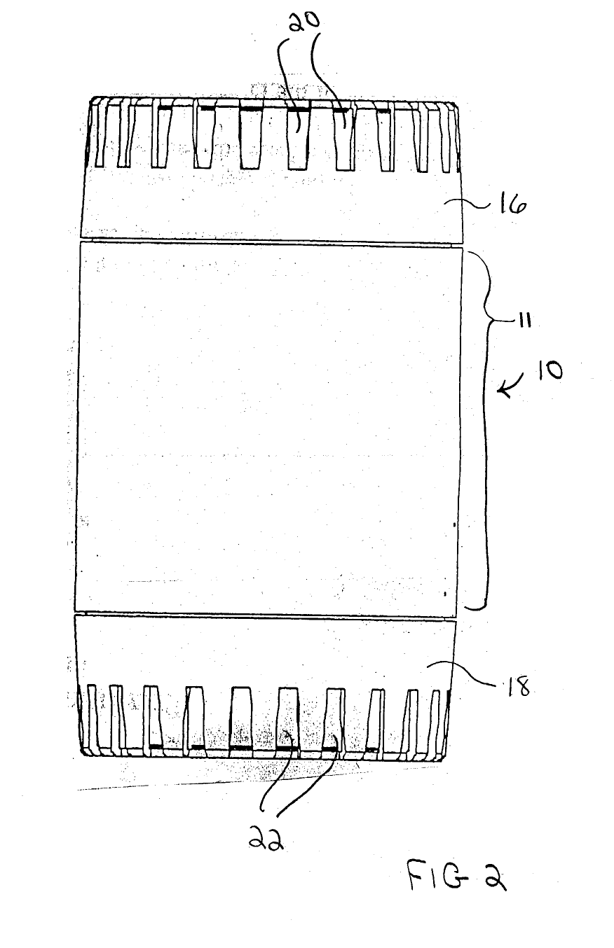

### DETAILED DESCRIPTION OF DRAWINGS

The present invention provides an air deodorizer which is ideally suited for use in a refrigerator. In preferred aspects, the present invention uses activated carbon as the deodorizing agent. An advantage of using activated carbon is that it absorbs the causes of odor. In contrast, existing air fresheners simply operate by merely emitting a “cover up” scent or perfume.

The inventor has found that activated carbon is unexpectedly more effective than baking soda at removing unwanted refrigerator odors. In addition, activated carbon is safe, harmless and easy to use. Thus, the present invention is ideally suited for use in a refrigerator.

Referring to the Figs., an air deodorizer 10 is provided. Air deodorizer 10 comprises a body portion 11 (which is preferably hollow) in which activated carbon is placed. In optional preferred aspects, the activated carbon may comprise high grade anthracite coal and/or coal binders.

The activated carbon may preferably be held in position between a top screen 12 and a bottom screen 14. Thus, air flows freely though the device passing through both screens 12 and 14. An advantage of positioning screens 12 and 14 at the respective top and bottom of the device is that it permits top-to-bottom and bottom-to-top air circulation. A top cover 16 and a bottom cover 18 may also be provided for attachment to body 11. Top cover 16 and bottom cover 18 may either be dimensioned to be snap-fit or to be screw-fit onto body 11. Optionally, gaskets 17 and 19 may be positioned (between screens 12/14 and covers 16/18 as shown) such that top and bottom covers 16 and 18 may be screw-fit (or snap-fit) into position, while preventing damage to screens 12 and 14. Alternatively, also keeping within the scope of the present invention, top cover 16 and bottom cover 18 may instead be integrally formed with body 11.

Top cover 16 and bottom cover 18 preferably comprise at least one vent 20 or 22 formed therein, thus permitting airflow through pellets of activated carbon that are stored in body 11.

In optional preferred aspects, the present invention is cylindrical in shape and built to be about the size of a soda pop can. Optionally, product insignia, labeling or advertising may be printed on the device. Thus, the present invention may be the same size as an 8 oz soda pop can, and even be labeled as such a recognized brand of soda pop. Therefore, the constant presence of the air freshener in the refrigerator can serve as a brand name reminder.

Body portion 11, and top and bottom covers 16 and 18 may be made of glass, plastic, crystal or any other suitable material. Gaskets 17 and 19 may be made of neoprene.

In optional preferred aspects, a material which removes ethylene gas may also be placed into body 11 of air deodorizer 10 (e.g.: mixed in with the activated carbon). Ethylene gas is the natural ripening agent which, when produced, causes fruits to ripen and decay, and vegetables and florals to wilt. Controlling (i.e.: reducing) ethylene gas will extend the shelf life of these products.

What is claimed is:

1. An air deodorizer comprising:
a housing having at least one opening permitting air flow therethrough; and
activated carbon disposed within the housing.

2. The air deodorizer of claim 1, wherein the at least one opening comprises:
vents at opposite ends of the housing.

3. The air deodorizer of claim 2, wherein the vents are disposed at the top and bottom of the housing.

4. The air deodorizer of claim 2, wherein the housing comprises:
top and bottom covers, and wherein the vents are disposed in the top and bottom covers.

5. The air deodorizer of claim 2, further comprising:
screens positioned at opposite ends of the housing adjacent to the vents, the screens holding the activated carbon therebetween, and preventing the activated carbon from exiting the housing through the vents.

6. The air deodorizer of claim 1, wherein the activated carbon is made from high grade anthracite coal or coal binders.

7. The air deodorizer of claim 1, wherein the housing is cylindrical in shape.

8. The air deodorizer of claim 1, further comprising:
advertising or promotional materials or insignia disposed around or printed on the housing.

9. The air deodorizer of claim 4, wherein the covers are snap-fit onto the body of the housing.

10. The air deodorizer of claim 4, wherein the covers are screw-fit onto the body of the housing.

11. The air deodorizer of claim 4, further comprising:
a gasket positioned between each of the covers and the screens at the top and bottom of the housing.

12. The air deodorizer of claim 1, further comprising:
material which removes ethylene gas mixed in with the activated carbon.
